(19) United States
(12) Patent Application Publication
(10) Pub. No.: US 2012/0199292 A1
(43) Pub. Date: Aug. 9, 2012

(54) PLY LOCKING FOR HONEYCOMB PANELS

(75) Inventors: Jonathan Bremmer, Glastonbury, CT (US); Neil W. Cawthra, Shelton, CT (US); Christian A. Rogg, New Milford, CT (US); Paul H. Denavit, Woodbridge, CT (US); William E. Hovan, III, Oxford, CT (US); Robert A. Lacko, Oxford, CT (US); Jeffrey G. Sauer, Woodbury, CT (US)

(73) Assignee: SIKORSKY AIRCRAFT CORPORATION, Stratford, CT (US)

(21) Appl. No.: 13/020,609

(22) Filed: Feb. 3, 2011

(51) Int. Cl. B32B 37/14

(52) U.S. Cl. 156/559

(57) ABSTRACT

A tool for forming a panel including a core area, at which plies sandwich a core, and a trim area surrounding the core, at which the plies are bonded together, is provided and includes a body having a surface on which the panel is formable, the surface including core and trim portions for respective correspondence with locations of the core and trim areas of the panel, a border between the core and trim portions defining a surface feature displaced from a plane of the core portion, a lock disposable proximate to the surface feature to increase a pre-bonding friction between the plies at the surface feature and an assembly to apply bonding pressure to the plies and the lock at least at the core and trim areas.

### FEDERAL RESEARCH STATEMENT

This invention at least partially arose out of work done on 53K supplier core crushing issue as part of Marine Corps Systems Command Contract No. N00019-16-C-0081 of Feb. 5, 2010.

### BACKGROUND OF THE INVENTION

The subject matter disclosed herein relates to ply locking for honeycomb panels.

Core crushing is a problem with autoclave curing of honeycomb panels at higher pressures. Honeycomb panels are typically formed of materials used to increase panel stiffness and are configured with a core made of honeycomb-shaped cells and a ramp at the core periphery. During assembly, the core is placed onto a tool and sandwiched between upper and lower laminates, which are squeezed together by, for example, a vacuum bag. Core crushing occurs when the pressure applied by the vacuum bag overcomes a strength of the core material and crushes the core against the tool. The height of the core, the core ramp angle, the position of the core and the maximum expected operating pressure (MEOP) all play into non-crush versus core crush results.

In particular, core crush often occurs when one or both of the laminates is permitted to move relative to the other laminate during the pressurization. This ply/panel movement tends to be directed toward the center of the core at the center of the tool and increases a degree of pressurization at the center of the core. Therefore, efforts to avoid crush results have often been concerned with preventing ply/panel movement. These efforts have included manufacturer use of grip strips and/or manufactured inserts to resist ply/panel movement but require that additional ply/panel material be provided at additional costs.

### BRIEF DESCRIPTION OF THE INVENTION

According to one aspect of the invention, a tool for forming a panel including a core area, at which plies sandwich a core, and a trim area surrounding the core, at which the plies are bonded together, is provided and includes a body having a surface on which the panel is formable, the surface including core and trim portions for respective correspondence with locations of the core and trim areas of the panel, a border between the core and trim portions defining a surface feature displaced from a plane of the core portion, a lock disposable proximate to the surface feature to increase a pre-bonding friction between the plies at the surface feature and an assembly to apply bonding pressure to the plies and the lock at least at the core and trim areas.

According to another aspect of the invention, a locking mechanism is provided and includes a tool having a core portion and a trim portion to encompass the core portion, the core and the trim portions defining a surface feature at a border therebetween and having an upper surface on which plies are layered to sandwich a core positioned at the core portion, a lock disposable proximate to the surface feature to squeeze the plies against the upper surface of at least one of the core and the trim portion to thereby increase friction between the laminates at the surface feature and an assembly to apply bonding pressure to the plies and the lock at least at the core and the trim portions.

According to yet another aspect of the invention, a method of forming a composite panel is provided and includes forming a tool surface with a surface feature, sandwiching a core between plies and placing the core and the plies on the tool surface such that the surface feature encompasses the core, pressing an upper one of the plies onto a lower one of the plies proximate to the surface feature and applying pressure to at least the upper ply substantially evenly over the core, the lower ply and the surface feature.

These and other advantages and features will become more apparent from the following description taken in conjunction with the drawings.

### BRIEF DESCRIPTION OF THE DRAWING

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is an enlarged side view of a tool for forming a panel;

FIG. 2 is a top-down view of the tool of FIG. 1 in accordance with exemplary embodiments;

FIG. 3 is a top-down view of the tool of FIG. 1 in accordance with alternate exemplary embodiments; and

FIGS. 4A and 4B are side views illustrating a core stabilization method.

The detailed description explains embodiments of the invention, together with advantages and features, by way of example with reference to the drawings.

### DETAILED DESCRIPTION OF THE INVENTION

The tool provided for herein includes a surface feature that minimizes excess material around a part/panel perimeter. In an exemplary embodiment, the tool has a step, a groove or relief in either a negative or positive direction in the trim area of the part (i.e., the non-design area), which allows the upper and lower plies of the honeycomb panel to be locked together. The plies will have an up or down directional change, which in combination with another structure or force will resist slipping motion of the plies during cure. As such, higher cure pressures will be permissible for panels resulting in better part quality, simple additions to tooling strings and minimized material edge waste around the part perimeter.

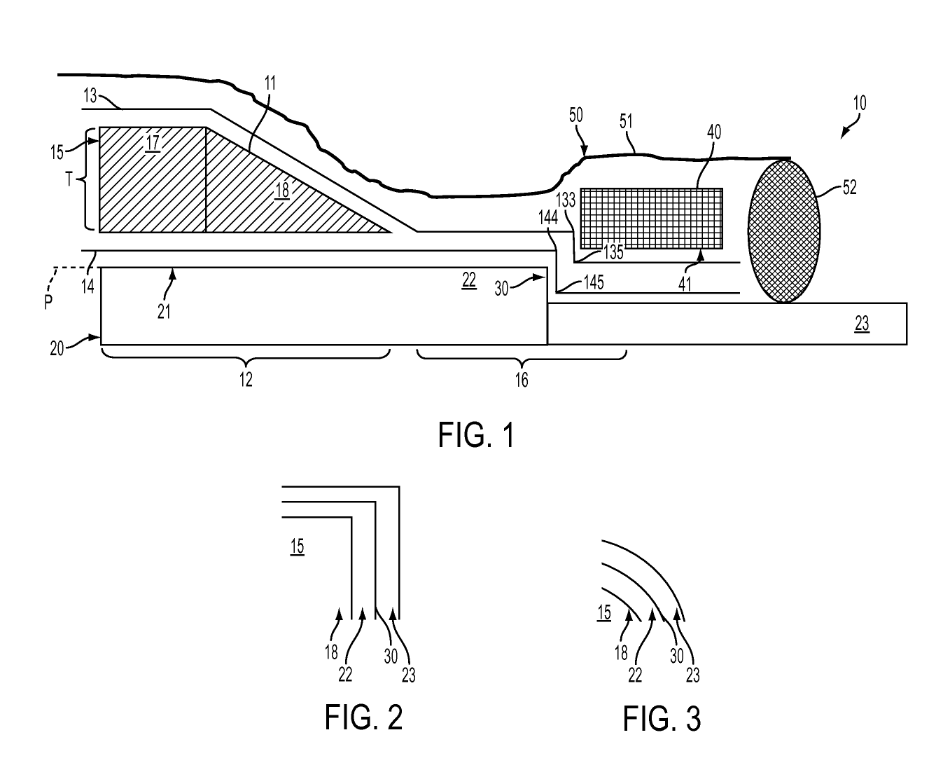

With reference to FIGS. 1-3, a tool 10 for forming a panel 11 is provided. The panel 11 includes a core area 12 at which an upper ply laminate 13 and a lower ply laminate 14 sandwich a core 15 and a trim area 16. The core 15 includes for example a central honeycomb panel 17 having thickness, T, or a panel formed of another cell arrangement and a ramped edge 18 that is tapered along a periphery of the central honeycomb panel 17. The trim area 16 surrounds the ramped edge 18 of the core 15 whereby the upper ply laminate 13 and the lower ply laminate 14 have nothing interposed between them and are therefore able to be bonded together.

The tool 10 includes a body 20, having a surface 21 on which the panel 11 is formable, a lock 40 and an assembly 50. The surface 21 defines a plane, P, from which the thickness, T, of the central honeycomb panel 17 may be measured and includes a core portion 22 and a trim portion 23. The core portion 22 corresponds in location to a location of the core area 12 when the panel 11 components are disposed on the tool 10. Similarly, the trim portion 23 corresponds in location to a location of an outer region of the trim area 16 when the panel 11 components are disposed on the tool.

That is, with the tool 10 provided as described above, the lower ply laminate 14 may be disposed or laid upon the surface 21 at the core portion 22 and an inner region of the trim portion 23. The core 15 may then be disposed on top of the lower ply laminate 14 such that a footprint or shape of the core 15 is encompassed within the core portion 22 in the plane, P. The upper ply laminate 13 is then laid on the core 15 and the lower ply laminate 14 such that the upper ply laminate covers the core 15 and the lower ply laminate 14 at the core portion 22 and the lower ply laminate 14 at the inner region of the trim portion 23.

A border between the core portion 22 and the trim portion 23 is formed to define a surface feature 30 including a part that is displaced from the plane, P, of at least the core portion 22. The surface feature 30 may be localized on the surface 21 or may extend around the core portion 22 to surround the core 15. As shown in FIGS. 2 and 3, the surface feature 30, the core portion 22, the trim portion 23 and the core 15 may have similar shapes. That is, if the ramped edge 18 of the core 15 is substantially rectangular (see FIG. 2) or ovoid (see FIG. 3), the surface feature 30, the core portion 22 and the trim portion 23 may similarly be rectangular or ovoid, respectively. Of course, it is to be understood that this is merely exemplary, however, and that, as long as the core 15 is encompassed within the surface feature 30, the surface feature 30, the core portion 22, the trim portion 23 and the core 15 may have different shapes in varying combinations.

The surface feature 30 may be any surface irregularity that either protrudes out of or is recessed with respect to the plane, P. In some cases, the surface feature 30 may protrude out of the plane, P, in some areas and be recessed from the plane, P, in other areas. In any case, the upper ply laminate 13 lays upon the lower ply laminate 14 and each assumes a cross-sectional layered pattern that is reflective of the form, shape and size of the surface feature 30. That is, if the surface feature 30 protrudes from the plane, P, the upper ply laminate 13 and the lower ply laminate 14 each curve away from the plane, P, in the positive direction. By contrast, if the surface feature 30 recedes from the plane, P, the upper ply laminate 13 and the lower ply laminate 14 each curve away from the plane, P, in the negative direction.

In an exemplary embodiment, as shown in FIG. 1, the core 15 is sandwiched between the upper and lower ply laminates 13 and 14 and positioned at the core portion 22, which is substantially flat and planar. Beyond the ramped edge 18 of the core 15, the upper and lower ply laminates 13 and 14 are layered on one another and the outer region of the core portion 22. At the border between the core portion 22 and the trim portion 23, the trim portion 23 is recessed from the plane, P. As such, the border between the core portion 22 and the trim portion 23 defines the surface feature 30 as a step-down from the core portion 22 to the trim portion 23 with substantially angular and, in some cases, right-angular corners. In this way, the upper and lower ply laminates 13 and 14 each form respective first bends 144 and 133 in the downward or negative direction at the start of the step-down proximate to the core portion 22 and respective second bends 145 and 135 in the upward or positive direction at the end of the step-down proximate to the trim portion 23.

The lock 40 is disposable proximate to the surface feature 30 to increase a pre-bonding friction between the upper and lower ply laminates 13 and 14 at the surface feature 30. The lock 40 may be singular in number and may extend around and encompass the core 15 and/or the surface feature 30. Alternatively, the lock 40 may be localized and positioned proximate to only one part of the surface feature 30. In still other cases, the lock 40 may be composed of a plurality of local components that are arranged around the core 15 and/or the surface feature 30. In any case, the lock 40 may include a grip surface 41 to increase frictional engagement between the lock 40 and a surface of the upper ply laminate 13. A similar grip surface may be provided on the surface 21 as well.

For the step-down surface feature 30 of FIG. 1, the lock 40 will generally be disposed at a periphery of the surface feature 30 whereby a weight of the lock 40 will squeeze the upper and lower ply laminates 13 and 14, which are not yet bonded, together between the lock 40 and the surface 21 at the trim portion 23. Friction generated between the upper and lower ply laminates 13 and 14 is therefore increased significantly at least at the first bends 144 and 134 and the second bends 145 and 135 at the angular corners of the surface feature 30. This increased friction will tend to restrict relative movement of one of the upper and lower ply laminates 13 and 14 relative to the other during subsequent bonding operations and will thereby decrease a likelihood of a crush result. The restriction of the relative movement can be further increased by the use of the grip portion 41 and/or a similar grip portion provided on the surface 21.

As described above, the lock 40 is disposed at and/or around a periphery of the surface feature 30. However, it is to be understood that this configuration is merely exemplary and that other configurations are possible. For example, where the core portion 22 is recessed from the trim portion 23 and the border defines the surface feature 30 as a step-up from the core portion 22 to the trim portion 23, the lock 40 may be disposed at either the periphery of the surface feature 30 or at an interior of a perimeter defined by the surface feature 30.

The assembly 50 applies ply laminate bonding pressure to the upper and lower ply laminates 13 and 14 and the lock 40 at the core area 12 and the trim area 16 and along the core portion 22 and the trim portion 23. In accordance with exemplary embodiments, the assembly 50 may include a vacuum bag 51, which is sealable via seal 52 to the surface 21, to apply the ply laminate bonding pressure substantially evenly when the vacuum bag 51 is evacuated. Due to the increased friction generated between the upper and lower ply laminates 13 and 14 by the effect of the squeezing effect of the lock 40 proximate to the surface feature 30, a likelihood that the substantially even ply laminate bonding pressure will cause relative movement between the upper and lower ply laminates 13 and 14 will be decreased.

In accordance with further aspects, a method of forming a panel 11 or, more particularly, a composite panel is provided and includes forming a tool 10 surface 21 with a surface feature 30 and sandwiching a core 15 between an upper ply laminate 13 and a lower ply laminate 14 and placing the core 15 and the upper and lower ply laminates 13 and 14 on the tool 10 surface 21 such that the surface feature 30 encompasses the core 15. The method further includes pressing the upper ply laminate 13 onto the lower ply laminate 14 proximate to the surface feature 30 and subsequently applying ply laminate bonding pressure to at least the upper ply laminate 13 substantially evenly over the core 15, the lower ply laminate 13 and the surface feature 30.

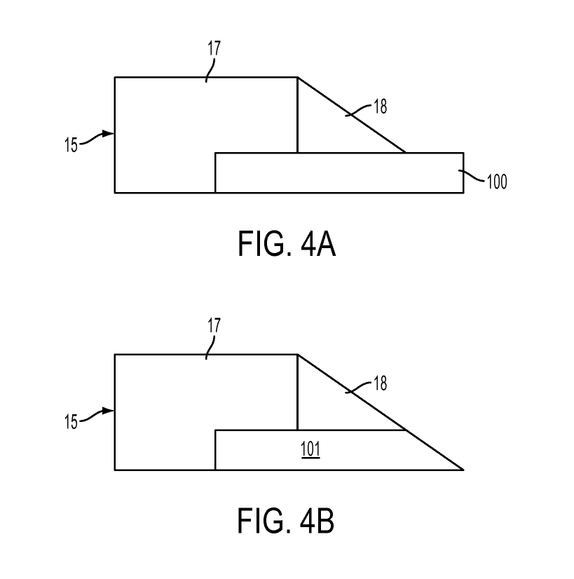

With reference to FIGS. 4A and 4B and, in accordance with further aspects of the invention, a core stabilization method using foam insertion is provided and serves to eliminate some processing operations associated with stabilization of the core 15. Core stabilization is used to prevent deformation of the core 15 during curing processes similar to and/or in addition to those discussed above when manufacturing honeycomb composite core panels in an autoclave. As described above, the processes require vacuum bagging and oven curing of the core 15 using film adhesives and/or certain types of fabrics.

Using foam insertion in addition to the features mentioned above strengthens and/or stabilizes the core at the central honeycomb panel 17 and the ramped edge 18 and in a direction that is substantially parallel to a ribbon direction of the core 15. The normal to ribbon direction is generally the weakest property of the core 15 and is the most likely surface to crush during autoclave fabrication.

The foam 100 may include, for example, 3-5 pcf closed cell foam, and can be inserted into open cells of the bottom surface of the core 15. The stuffed core 15 is then stronger when filled. The foam 100 has the temperature capacity and is chemically resistant to the autoclave/materials it will be cured with (Rohacell, Klegecell, Urethane or equivalent based on foam strength). The 100 foam allows all the standard processing methods to be used but allows for higher processing pressures for better laminates. Once it is inserted into the core 15, the surfaces of the foam 100 can be sanded and shaped to conform to the desired shape of the ramped edge 18 and to form a shaped foam portion 101 within the core 15.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A tool for forming a panel including a core area, at which plies sandwich a core, and a trim area surrounding the core, at which the plies are bonded together, the tool comprising:
a body having a surface on which the panel is formable, the surface including core and trim portions for respective correspondence with locations of the core and trim areas of the panel, a border between the core and trim portions defining a surface feature displaced from a plane of the core portion;
a lock disposable proximate to the surface feature to increase a pre-bonding friction between the plies at the surface feature; and
an assembly to apply bonding pressure to the plies and the lock at least at the core and trim areas.

2. The tool according to claim 1, wherein the core comprises a central honeycomb panel and a ramped edge.

3. The tool according to claim 2, wherein the core portion encompasses the central honeycomb panel and the ramped edge in the plane thereof.

4. The tool according to claim 3, wherein the surface feature surrounds the core portion.

5. The tool according to claim 3, wherein the surface feature, the core portion and the core each have substantially similar shapes.

6. The tool according to claim 1, wherein the trim portion is recessed from the plane of the core portion at the border to define the surface feature.

7. The tool according to claim 6, wherein the surface feature comprises a step having angular corners from the core portion to the trim portion.

8. The tool according to claim 6, wherein the lock is disposable beyond a periphery of the surface feature.

9. The tool according to claim 6, wherein the lock is singular in number, extends around and encompasses the surface feature.

10. The tool according to claim 1, wherein the lock comprises a grip surface to increase frictional engagement between the lock and an upper one of the plies.

11. The tool according to claim 1, wherein the assembly comprises a vacuum bag, which is sealable to the surface, to apply the bonding pressure substantially evenly at the core and trim areas.

12. A locking mechanism, comprising:
a tool having a core portion and a trim portion to encompass the core portion, the core and the trim portions defining a surface feature at a border therebetween and having an upper surface on which plies are layered to sandwich a core positioned at the core portion;
a lock disposable proximate to the surface feature to squeeze the plies against the upper surface of at least one of the core and the trim portion to thereby increase friction between the laminates at the surface feature; and
an assembly to apply bonding pressure to the plies and the lock at least at the core and the trim portions.

13. The locking mechanism according to claim 12, wherein the respective upper surfaces of the core and the trim portions are substantially flat at locations remote from the surface feature.

14. The locking mechanism according to claim 12, wherein the core comprises a honeycomb panel and a ramped edge.

15. The locking mechanism according to claim 12, wherein the surface feature and the core have substantially similar shapes.

16. The locking mechanism according to claim 12, wherein the lock comprises a single member extending around the surface feature.

17. The locking mechanism according to claim 12, wherein the lock comprises a grip surface to increase frictional engagement between the lock and an upper one of the plies.

18. The locking mechanism according to claim 12, wherein the surface feature comprises an angular step from a plane of the core portion to a plane of the trim portion.

19. The locking mechanism according to claim 12, wherein the assembly comprises a vacuum bag, which is sealable to the upper surface of the trim portion, to apply the bonding pressure substantially evenly at the core and trim portions.

20. A method of forming a composite panel, the method comprising:
forming a tool surface with a surface feature;
sandwiching a core between plies and placing the core and the plies on the tool surface such that the surface feature encompasses the core;
pressing an upper one of the plies onto a lower one of the plies proximate to the surface feature; and
applying pressure to at least the upper ply substantially evenly over the core, the lower ply and the surface feature.

21. The method according to claim 20, further comprising:
inserting strengthening and/or stabilizing foam into the core; and
sanding and shaping the foam to conform to a shape of the core.
